(19) United States
(12) Patent Application Publication
(10) Pub. No.: US 2008/0271022 A1
(43) Pub. Date: Oct. 30, 2008

(54) UTILIZING GRAPHS TO DETECT AND RESOLVE POLICY CONFLICTS IN A MANAGED ENTITY

(75) Inventors: John C. Strassner, North Barrington, IL (US); David L. Raymer, Watauga, TX (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/740,977

(22) Filed: Apr. 27, 2007

(51) Int. Cl. G06F 9/46

(52) U.S. Cl. 718/100

(57) ABSTRACT

A method and system are disclosed for changing the structure of one or more policies and/or the order of application of one or more policies to resolve conflicts among a set of policies using graph-theoretic techniques. Policies are used to govern the states of managed entities (e.g., resources and services). The set of states of the set of managed entities are represented as nodes of a graph. The output of the set of applicable policies governing all or part of the nodes is then used to control the transition between some or all nodes in the graph.

### CROSS-REFERENCE TO RELATED APPLICATIONS

This patent application is related to U.S. patent application Ser. No. 11/618,125, Attorney Docket Number CML04644MNG, filed on Dec. 29, 2006, commonly assigned to the assignee hereof, and the entire disclosure of which is herein incorporated by reference.

### FIELD OF THE INVENTION

This invention relates in general to policy management, and more particularly, to utilizing policies to resolve conflicts in weighted, directed graphs of managed entities.

### BACKGROUND OF THE INVENTION

Policies are used to orchestrate the behavior of a system. Large systems often have a large number of policies that interact in many different ways. Unfortunately, changing business needs and environmental conditions change the policies used and their order of application in unforeseen ways.

Policy conflicts can arise due to several reasons. For instance, conflicts can arise due to: (1) an administrator trying to express conflicting requirements, (2) multiple administrators expressing conflicting domain-specific requirements, (3) different constituencies expressing conflicting requirements, (4) lack of knowledge on how to handle a particular condition (usually an error, but may also be a task to optimize performance), or (5) unexpected combinations of policies-usually, when several policies apply to the same set of managed elements, there is a potential for conflict. There are many other reasons as well.

Currently, there are no preferred ways of resolving policy conflicts. One of the difficulties in resolving conflicts is determining a way for the system to know not only that the conflict has been resolved, but that the conflict has been resolved in the best possible manner. The currently-known art defines a static set of conditions that define when policy is applied. However, static conditions lead to at least seven important limitations in the art. They are:

Inability to reorder policies to take into account changing business needs or environmental conditions (e.g., if a reconfiguration requires three separate steps that involve three different state changes, one realization could require three different policies; the policies might need to be reordered to suit current business needs and/or environmental conditions);

Inability to adjust the applicability of a given policy (without changing its structure or content) to account for its varying relevance (e.g., as a function of changing context, user needs, or business rules);

Inability to choose the best set of policies, among a set of applicable policies, that must be applied in a particular order, to move the system (or a component of the system) to a new desired state;

Inability to efficiently detect policy conflicts in a large, complex system of interrelated policies;

Inability to detect policy conflicts that are not directly related to managed elements that are being monitored—this is extremely common in networks, due to the complexity of the network and the large number of managed elements (e.g., device interfaces, physical and virtual), along with the inherent changing connectedness of a network; it is difficult, if not impossible, to properly instrument the system;

Inability to relate a set of constraints to a function that determines the weighting factor that a policy should have relative to other policies; and

Inability to associate the governance offered by a policy with a changing weighting factor to accommodate changing contexts.

In summary, there is no current way to structure and reorder policies to adapt to changing business priorities, user needs, and environmental conditions. Furthermore, the art does not address the interdependencies between policies, which often lead to the problem of fixing one thing, but causing problems in another. In addition, there is no current way in the art to easily alter the impact of policies on what they manage without rebuilding the entire analysis.

Therefore, a need exists to overcome the problems with the prior art as discussed above.

### SUMMARY OF THE INVENTION

A method and system are disclosed for changing the structure of one or more policies and/or the order of application of one or more policies to resolve conflicts among a set of policies using graph-theoretic techniques. This invention defines how policies can be used to govern the states of managed entities (e.g., resources and services). The set of states of the set of managed entities are represented as nodes of a graph. The output of the set of applicable policies governing all or part of the nodes is then used to control the transition between some or all nodes in the graph. This is done by associating a weighting function with each policy, such that the weight of a transition between two states is determined by one or more actions of one or more policies. Conflicts can be detected by determining if multiple equally weighted paths exist between the same source and destination in the graph; these can be resolved by changing the policy weighting function, which has the effect of choosing one path over the other conflicting paths without changing the structure of the graph. Context can be used to alter where the weighting function is applied as well as change the value of one or more weighting functions; this in effect enables the system to vary the set of policies applied according to changes in context.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a process flow diagram illustrating an algorithm used to detect and resolve conflicts among policies in a policy-based system, according to an embodiment of the present invention.

FIG. 2 is a weighted, directed graph of managed entities, according to an embodiment of the present invention.

FIG. 3 is the weighted, directed graph of managed entities of FIG. 2 with a multiple policies applying multiple functions to edges of the graph, according to an embodiment of the present invention.

FIG. 4 is a high-level block diagram of a policy server, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The present invention provides a novel and efficient method and device for changing the structure of one or more policies and/or the order of application of one or more policies to resolve conflicts among a set of policies using graph-theoretic techniques.

Embodiments of the present invention define how policies can be used to govern the states of managed entities (e.g., resources and services). The set of states of the set of managed entities are represented as nodes of a graph. The output of the set of applicable policies governing all or part of the nodes is then used to control the transition between some or all nodes in the graph. For example, one or more policies can be used to change the cost of one or more transitions, thereby changing the path(s) that will be preferred. While this in itself is novel, further novelty is found by associating a weighting function with each policy, such that the weight of a transition between two states is determined by one or more actions of one or more policies. This enables the applicability of a policy to be taken into account, which in turn enables the set of policies to vary the weight (i.e., desirability) of a particular set of transitions. Conflicts can be detected by determining if multiple equally weighted paths exist between the same source and destination nodes in the graph. Conflicts can then be resolved by changing the policy weighting function, which has the effect of choosing one path over the other conflicting paths. This is advantageous because the graph itself (i.e., the nodes of the graph and the transitions that connect the nodes) never need to be changed. In one embodiment, context can be used to alter where and how policies apply their weighting functions (i.e., the particular set of transitions in a graph) as well as to change the value of one or more weighting functions; this, in effect, enables the system to change the set of policies applied as well as their effect according to changes in context. For the purposes of this invention, the context of a managed entity is defined as the set of specific conditions, external to the managed entity itself, which determine the behavior of the managed entity. Examples of such conditions include time, environmental and network conditions, location (and its surroundings), audience, and other factors.

An information model and/or data model(s) defines the characteristics and relationships of the policies, resources and services in a system. In general, the resource topology is first defined; then, the set of services is overlaid on top of the available resources. This configuration reflects the real-world dependency that services cannot exist in the ether—they must instead be hosted or bound to available resources. This also enables the present invention to take into account interruption of resource availability to services.

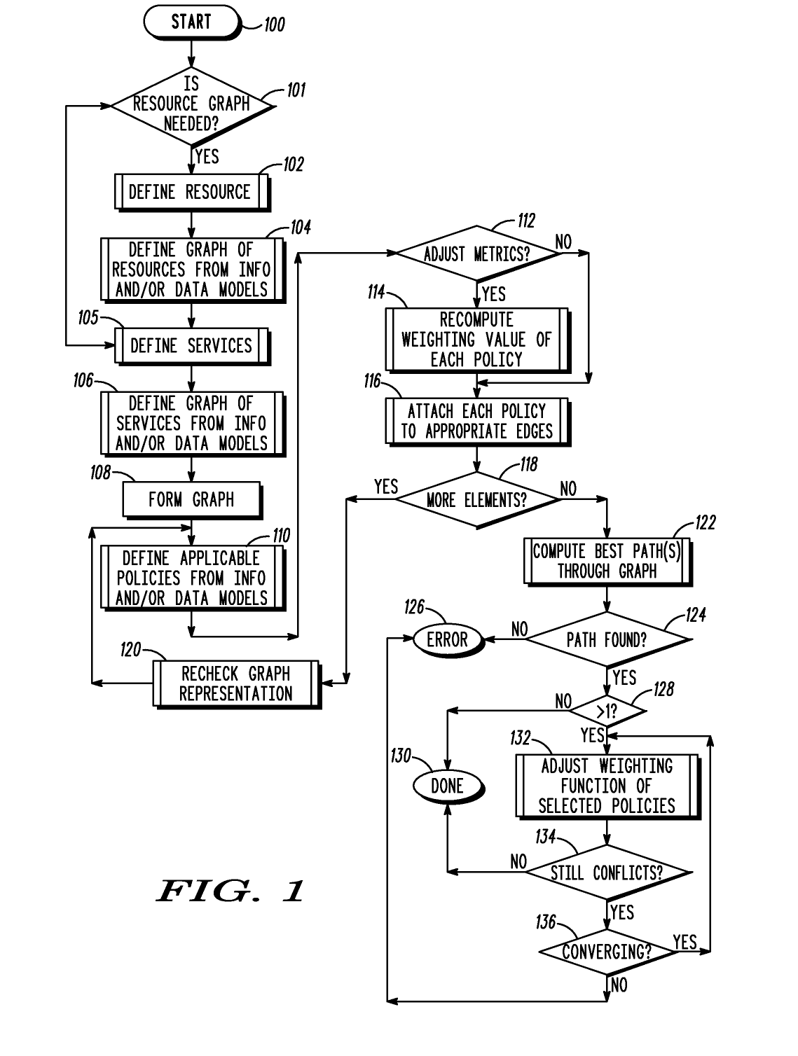

A flowchart depicting the overall logic process governing how policy is used to affect the weight of one or more transitions in a graph is shown in FIG. 1. Policies are used to govern both resources and services; for simplicity, this discussion addresses only the optimization of services on resources (the case of resource optimization is a subset of the case presented here). The flow begins at step 100 and moves directly to step 101 where a determination is made as to whether resources are available that need to be graphed. If the answer is no, the flow moves to step 105. If the answer is yes, the flow moves to step 102 where a set of resources R={R1, R2, . . . , Rn} that represent the set of resources that are to be governed are defined. Any physical topological discovery algorithm can be used to find these resources; alternatively, they can be entered from externally known data. In step 104 a graph of the resources is defined, where state changes of the resources are the nodes of the resource graph, and the state transitions of the resources are the edges of the resource graph.

In step 105, a set of services S={S1, S2, . . . , Sn} that represent the set of services that are to be governed are defined. Note that the approach of first, defining resources, and second, defining services, mirrors the real-world constraints of any system. Services are inextricably bound to resources; hence, the present invention is able to detect policy conflicts between resources and services as well as between just resources and just services. The ability to optionally consider this alternative is advantageous, as it has significant implications with respect to computational complexity (and hence, speed of decision-making), as well as the hardware and software (i.e., the “footprint” of the system) required to implement this invention. This also enables this invention to be used in systems in which the resource availability is fixed.

In step 106 a graph of services is defined, where state changes of the services are the nodes of the service graph, and state transitions are its edges. A graph of the system is formed in step 108 by first, representing the state changes of each of the resources and/or services (elements of R and/or S) as different nodes in the graph and second, representing the cost of the connection between nodes as a set of Edges (where in general, a connection between resources Rᵢ and Rⱼ (or services Sᵢ and Sⱼ) is represented by edge Eᵢⱼ, and the set of all edges E is represented as E={E₁₁, E₁₂, . . . , E₁ⱼ, E₂₁, . . . , Eᵢⱼ}). The graph can be a set of nested graphs, a set of pseudographs, and/or a set of hypergraphs. Other representations are also possible.

In step 110, a set of policies P={P₁, P₂, . . . , Pₙ} is defined that can be used to govern each of the resources and services in R and S. This is done by examining associations in the information and data models between a given resource and/or service and the policies that could be applied to it. Basically, if there is a direct association, then the policy is mandatory. If there is an indirect association, the data model will be examined. If instances exist, it is mandatory; if instances do not exist, then it is optional. If, however, there is no association between policy and resource or service, then the policy does not apply.

Each connection in the graph (represented by Eᵢⱼ) has an associated cost, defined by any conventional means that is appropriate (called its conventional cost Cᵢⱼ). Each policy Pᵢ can be used to govern one or more of the edges Eᵢ in the set E (if there is no such policy, then its cost is simply Cᵢⱼ); this then provides a new cost C(Pᵢⱼ). It is assumed that there are a set of such costs, for all policies Pᵢ that affect a given edge Eᵢ, since one or more policies may affect the overall cost of the same edge Eᵢ. This provides flexibility in modeling complex real-world networks, wherein a set of rules are imposed to govern the same managed resource. For example, a given device interface may have a set of security policies in addition to a set of quality of service policies applied to it. Another example is when several administrators apply their own set of policies to the same managed entity. In order to connect two nodes, the policy associated with the edge connecting the two nodes (e.g., Pᵢ) must first be executed (i.e., the successful resolution of its actions are determined). Note that if a policy Pᵢ does not execute successfully, then all edges that the policy Pᵢ governs will be disabled. Conceptually, this means that the policy did not allow or enable those edges to be used. The output of a particular policy Pᵢ may be thought of as defining the cost of using that edge, and corresponds to the value of a weighting function Wᵢ, where the value of the weighting function Wᵢ is determined by the resolution of the actions of the policy Pᵢ and its metadata (e.g., the overall execution strategy of the policy). Hence, the cost of the edge Eᵢ can be defined (according to a particular application-specific execution strategy) as one of the following:

Wᵢ*Cᵢⱼ, where Wᵢ is the weighting function of the set of policies that govern edge Eᵢ, and Cᵢⱼ is the conventional cost of the edge Eᵢ; this represents the policy weighting the conventional cost of the Edge Eᵢ;

Wᵢ, which represents the replacement of the conventional cost Cᵢⱼ with the new weighted policy cost;

The conventional cost Cᵢⱼ, which means that the effect of the Policy was 1 (i.e., the edge transition was enabled by policy); and

0, which means that the edge transition was not allowed (i.e., the edge was disabled by policy).

Optionally, the information available can be augmented from the information model and set of data models with ontological information. Ontologies are used to provide additional semantics augmenting the knowledge available from the models, which enables one or more forms of machine-based learning and/or reasoning algorithms to be applied. For example, consider the following policies:
John receives GoldService; and
FTP receives BronzeService;

Assume that GoldService provides more revenue to the Service Provider than BronzeService. Most policy algorithms cannot detect that a conflict may occur because John may use FTP (hence, the question is whether John's use of FTP would receive Gold or Bronze Service). An even more difficult problem is if the second policy rule (FTP receives BronzeService) is replaced by, for example, “Customers receive BronzeService by default”. The use of ontologies enables the semantics of both of these sets of policies to be more clearly specified, which in turn enables deducing whether GoldService and/or BronzeService should be preferred under what conditions. For example, while the default may indeed be to use BronzeService, certain conditions may cause this to be the wrong decision to take. Specifically, if the number of BronzeService users times their collective revenue is greater than the number of GoldService users times their collective revenue, it would be more advantageous to enable BronzeService users to win conflicts for services resources with GoldService users, even though GoldService has a greater revenue associated with it.

Note that the advantage of using information and data models is that as the managed system changes in functionality, the models can be updated to reflect these changes, which in turn automatically updates relationships to policies; similarly, as policies are created in or removed from the system, they can be attached or detached automatically to the existing services and resources of the system.

The flow then moves to step 112 where, for each possible scenario, zero or more metrics are adjusted in the policies governing the service. Each metric relates the policy to the overall goals of the system, a set of devices in the system, a set of edges in the graphs, and/or the particular state that a given managed entity should take, given a set of inputs or context. If a metric is adjusted, then the weighting function of the Policy is recomputed in step 114. The weighting function of the Policy is a function of the effects that the set of actions that the Policy contains has on the service or resource. Conceptually, each Policy contains one or more Actions, and each Action can affect one or more properties of the service or resource (as well as its behavior). Each application will have its own requirements on how the characteristics and behavior of a given service or resource are optimized. The present invention does not direct how an application has to interact with its services or resources; rather, it takes those functions into account in its weighting function. Hence, it is not necessary for the present invention to prescribe the weighting function. Rather, the invention defines the use of a weighting function that can be used with any application-specific approach by adjusting how the metrics are used.

In step 116, the set of policies, each with their own specific weighting function, are attached to the set of edges in the graph that they will govern. As previously stated, the weighting function is used to adjust the cost of each edge in the graph. For example, each action can be viewed as part of an overall weighted multiplier; hence, the weighting function value is the sum of the weight of each individual action. As another example, the policy can make the cost of the edge infinite, effectively removing it from the graph (this represents the inability of a node to transition to a new state because of a policy violation). In another example, each action can be viewed as an equally weighted multiplier; hence, the weighting function value is the product of the weight of each individual action.

Similarly, if more than one policy is used to govern a particular edge, then the weighting function of each policy can be used or ignored according to the specific needs of the application designer. Examples include:
The overall weighting function is the sum of the weighting function of each individual policy;
The overall weighting function is the product of the weighting function of each individual policy;
The overall weighting function is the greatest valued weighting function of all weighting functions for all policies for that edge; and
The overall weighting function is the least valued weighting function of all weighting functions for all policies for that edge.

Policy can be used to control the state of the system. Since the weighting function of a policy affects the cost of an edge, the weighting function can be used to define if a state change is permissible or not (i.e., the lower the cost of an edge, the more an edge is preferred; if the cost of an edge is greater than some threshold, then that edge cannot be traversed). Two different state types can be controlled in this manner: (1) the initial state change that triggers the application of policy, and (2) the subsequent state changes that occur due to the application of policy. Note that by adjusting the weighting, both reordering paths between a source and a destination as well as resolving conflicts can be achieved.

A check is performed in step 118 to see if more elements exist that have not been analyzed yet. As more elements are found, the choice of graph representation is continually revisited, step 120, to ensure that it is appropriate for the given graph. Once weights are attached to all edges of the graph, and no new elements are located, any appropriate graph optimization algorithm is used in step 122 to compute the best path through the graph. Note that since this is a policy-based system, instead of throwing away all non-optimal paths, embodiments of the present invention will, in general, retain some percentage of these paths (for example, those whose cost is above a pre-determined threshold). This enables fast handover to a different policy when or if a resource fails.

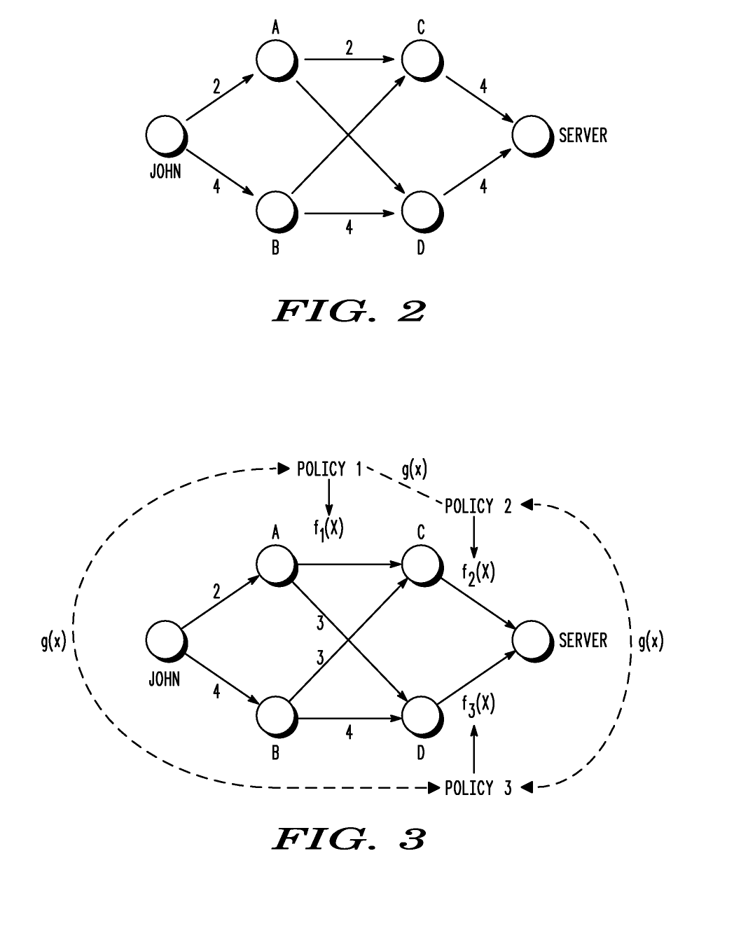

A check is performed in step 124 to see if an optimum path can be found. An optimum path is typically defined as the path having the lowest total cost, where cost is a quantitative measurement of value of a segment the path. If an optimum path cannot be found, the process aborts and raises an error in step 126. There should always be one or more paths that are less expensive than the other paths. Even if all of the paths have the same cost, they should be flagged as the optimum path because no other path is less expensive. If an optimum path is found, a check is performed in step 128 to determine if more than 1 path was flagged as optimum. If the answer to step 128 is no, a single least cost path has been located and the process finishes at step 130. This means that there were no policy conflicts found. However, if there are multiple optimum paths (indicating that one or more policy conflicts were found), the flow moves to step 132 and adjusts the weighting function of one or more policies associated with one or more of the paths. The adjustment is in accordance with the goals and process described above and also described below with reference to FIGS. 2 and 3.

The flow then moves to step 134, where a check is made if the adjustment has found a single least cost path. If so, then the conflicts have been resolved, and the flow moves to step 130 and concludes. If not, then the flow must check to determine if the process is “converging.” In this context, “convergence” means that there are less conflicts than in the previous step. In some cases, convergence can also apply even though there are still the same number, or more, conflicts, as long as the conflicts that remain are more easily solved. There are a number of mathematical algorithms for calculating convergence; any of these algorithms can be used and, accordingly, will not be discussed. If it is determined in step 136 that the determined conflicts are converging, the flow moves back up to step 132 where a weighting function of one of the policies is adjusted. If the conflicts are not converging, then the process aborts and an error is raised in step 126.

FIG. 2 shows a graph where an embodiment of the present invention can be utilized to resolve a policy conflict. In FIG. 2, the path John→A→C→Server is clearly optimal, since it has the lowest total cost, 8. This path is assigned to “GoldService”, as lowest cost is equated here to the highest level of service. Similarly, “BronzeService” could be assigned to the path John→B→D→Server, with a total cost of 12, to ensure that each service does not use nodes utilized by the other service, and hence adversely impacts, the other service.

An advantage of the present invention is that the structure of the graph does not have to change when conflicts are analyzed. This is illustrated in FIG. 2 by changing the cost of the edge A→D from 3 to 1. This changes GoldService from John→A→C Server (its original path) to John→A→D Server. Note that in this instance BronzeService may be affected, since the node D is used by both GoldService and BronzeService. The present invention detects this and, depending on the characteristics of the services and the applications using them, may recommend changing BronzeService from John→B→D→Server to John→B→C→Server. This is where the use of ontologies are especially helpful, since they provide additional relationships that can help decide if node D is capable of hosting two different classes of service concurrently or not.

It should be noted that instead of randomly changing an edge value, the present invention uses a policy to determine the cost of the edge. As an example of a simple embodiment of the present invention, a policy f(x) is applied to a single Edge A→B. This enables the cost of the Edge A→B to be controlled by an external function. In other words, the structure of the graph has nothing to do with the cost of the edges connecting the nodes of the graph.

Continuing further, as shown in FIG. 3, an embodiment of the present invention coordinates multiple policies, so that changing the cost of one edge can influence the changing of the cost of another edge. Visually, the policies can be thought of as being connected by a lattice-type structure, each of which controls one or more edge costs, as shown in FIG. 3.

In FIG. 3, Policy1 applies a function f₁(x) to edge A→C, Policy2 applies a function f₂(x) to edge C→Server, and Policy3 applies a function f₃(x) to edge D→Server. In this embodiment, Policy1, Policy2, and Policy3 are all related to each other by the function g(x). In one embodiment, each of the policies, Policy1, Policy2, and Policy3, include metadata to denote its association with the function g(x) to enable this coordination. Relating a group of policies with a single function enables coordination of their respective cost functions (f₁, f₂, and f₃), which in turn enables portions of the graph to be changed in a related manner. Of course, not all functions have to be coordinated. However, this feature becomes very useful when controlling related nodes (i.e., sub-graphs). For example, this could be applied in network management by defining different sub-graphs for similar elements, such as Virtual Lans, autonomous systems, subnets, and so forth.

One feature of the present invention is to adjust the applicability of a policy by adjusting its metrics and hence, the value of its weighting function. Another feature may be extended to relating context and hence, context changes, to alter where and how policies apply their weighting functions, since this enables the system to change the policies that it employs to govern system behavior according to changes in context.

For simplicity, models can be used to enable the present invention to reflect changes in the characteristics and topology of the nodes as a function of changes in the models. Code generation techniques (a simple example of which is MDA (model-driven architecture—see www.omg.org/mda)) can be used to generate changes to the graph independent of the cost functions used. That is, a change to the model could generate a new topology, which could immediately be analyzed for changes to affected services and resources.

Referring still to FIG. 3, assume that there are at least two paths between John and the Server which have the same costs but whose final link produces different actions (e.g., the action of the “C→Server” edge is “Set to GoldService”, while the action of the “D→Server” edge is “Set to BronzeService”. This is clearly a conflict. An algorithm according to the present invention identifies this as a conflict because the cost of the two (or more) paths is equivalent, they have the same source and destination, but apply different actions. The inventive algorithm solves this by enabling a mathematically provable solution to find a single least cost by systematically varying the cost of the edges of one or more of the conflicting paths, looking for a solution in which only one path has the least cost. Notably, the underlying model is able to constrain how path costs can be manipulated, because the underlying model represents the semantics of how a node communicates to other nodes, and controls this communication via policy. Note further that by varying the metrics for each policy, the control can be further fine-tuned.

“Cost” can be defined by at least one of the following:

The product of a path's conventional cost and the weighting function of a policy governing that connection; this enables the same node to have different weights (and hence, different applicabilities) based on the particular policy (or set of policies) that is currently active;

The choice of either its conventional cost or the weighting function of a policy governing that connection; this enables the policy to override the normal cost of the edge; and

The choice of either its conventional cost or 0 (i.e., able or not able to be traversed, respectively); this enables the policy to serve as an access control function that enables or disables an edge from being used.

As stated above, a Policy Pᵢ can govern one or more edges. While there are many ways to determine the particular set of edges that Pᵢ can govern, embodiments of the present invention use an information model and/or data models to do this because:

the information and/or data models provides a standard set of relationships between a policy and the set of resources and services that it governs, and hence can be used in multi-vendor environments;

optionally, knowledge from the information and/or data models can be augmented by ontological information, in order to provide more accurate and detailed graphs;

additional detail can be easily added to the policies, resources and services that the information model and/or data models represents (i.e., the solution is future-proofed); and

code generation techniques can be applied to the information and/or data models, resulting in a more efficient and faster turn-around than other means, such as hand-crafting code.

In addition, what-if analyses, based on statistical and/or game-theoretic population of edge transitions of the graph, can be analyzed by embodiments of the present invention, to check for conflict resolutions that are “better” according to one or more metrics. The system can then produce a ranking, according to one or more metrics, that provide recommendations on particular sets of policies to use given said metrics; this enables the invention to incorporate changing policy conflict resolution strategies that are either automatically or selectively applied to all policies via the weighting function without changing the graph or the policies (this is done by adjusting the weighting functions of affected policies).

Embodiments of the present invention define the applicability of a given policy (as well as the edge that the policy governs) as a set of metrics (e.g., average availability, bandwidth, and so forth). The weighting function W1 takes these metrics into account and, as one or more of the metrics change, the output of the weighting function changes. Changing the weighting function changes the path(s) through the network, which can be used to resolve policy conflicts.

Furthermore, the weighting factor can be used as is, or as a multiplying factor to the conventional cost of the connection. Therefore, the methodology chosen to resolve policy conflicts becomes a function of optimizing the graph according to different metrics (which can reflect application-specific needs) at any given point in time.

Policy Server

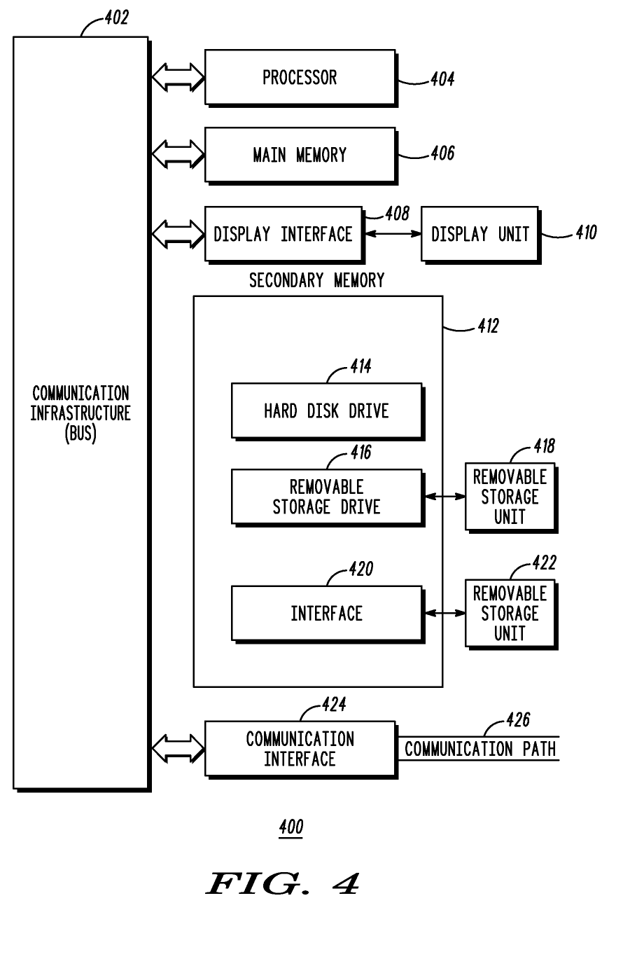

FIG. 4 is a high level block diagram illustrating a detailed view of a computing system 400 useful for implementing a policy server according to embodiments of the present invention. The computing system 400 is based upon a suitably configured processing system adapted to implement an exemplary embodiment of the present invention. For example, a personal computer, workstation, or the like, may be used.

In one embodiment of the present invention, the computing system 400 includes one or more processors, such as processor 404. The processor 404 is connected to a communication infrastructure 402 (e.g., a communications bus, crossover bar, or network). Various software embodiments are described in terms of this exemplary computer system. After reading this description, it will become apparent to a person of ordinary skill in the relevant art(s) how to implement the invention using other computer systems and/or computer architectures.

The computing system 400 can include a display interface 408 that forwards graphics, text, and other data from the communication infrastructure 402 (or from a frame buffer) for display on the display unit 410. The computing system 400 also includes a main memory 406, preferably random access memory (RAM), and may also include a secondary memory 412 as well as various caches and auxiliary memory as are normally found in computer systems. The secondary memory 412 may include, for example, a hard disk drive 414 and/or a removable storage drive 416, representing a floppy disk drive, a magnetic tape drive, an optical disk drive, etc. The removable storage drive 416 reads from and/or writes to a removable storage unit 418 in a manner well known to those having ordinary skill in the art. Removable storage unit 418, represents a floppy disk, a compact disc, magnetic tape, optical disk, etc. which is read by and written to by removable storage drive 416. As will be appreciated, the removable storage unit 418 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 412 may include other similar means for allowing computer programs or other instructions to be loaded into the policy server. Such means may include, for example, a removable storage unit 422 and an interface 420. Examples of such may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to the computing system 400.

The computing system 400, in this example, includes a communications interface 424 that acts as an input and output and allows software and data to be transferred between the policy server and external devices or access points via a communications path 426. Examples of communications interface 424 may include a modem, a network interface (such as an Ethernet card), a communications port, a PCMCIA slot and card, etc. Software and data transferred via communications interface 424 are in the form of signals which may be, for example, electronic, electromagnetic, optical, or other signals capable of being received by communications interface 424. The signals are provided to communications interface 424 via a communications path (i.e., channel) 426. The channel 426 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 406 and secondary memory 412, removable storage drive 416, a hard disk installed in hard disk drive 414, and signals. The computer program products are means for providing software to the computer system. The computer readable medium allows the computer system to read data, instructions, messages or message packets, and other computer readable information from the computer readable medium.

Computer programs (also called computer control logic) are stored in main memory 406 and/or secondary memory 412. Computer programs may also be received via communications interface 424. Such computer programs, when executed, enable the computer system to perform the features of the present invention as discussed herein. In particular, the computer programs, when executed, enable the processor 404 to perform the features of the computer system.

### CONCLUSION

As should now be clear, embodiments of the present invention provide an efficient method for using policy to enable or disable an edge transition, as well as change the weight of a particular edge transition; these mechanisms are used to resolve policy conflicts by providing a different policy to use, or remove a conflict by disabling the associated edge transition, or remove a conflict by changing the path taken through the graph. The enablement/disablement and cost mechanisms both use a weighting function that is associated with each policy, which enables policy control of behavior exhibited by the graph; specifically, the cost of a connection between two nodes can be adjusted according to a policy, meaning that the graph can be re-purposed without changing any of its elements. In addition, groups of policies can be linked together, so that changing one policy's weighting function could in turn cause the weighting functions of other policies to change e.g. FIG. 4 g(x).

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for resolving policy conflicts, the method comprising:
determining if at least two paths in a weighted, directed graph of managed entities have an equivalent cost that is better than a cost of all other paths in the weighted directed graph of managed entities, where weights are determined by one or more policies and the cost is a quantitative measurement of a cumulative value of the weights assigned to each edge making up the at least two paths; and
adjusting at least one weighting function associated with at least one edge connecting one or more nodes of at least one of the at least two paths to find a single lowest cost path

2. The method according to claim 1, further comprising:
determining, after the adjusting, a lowest-cost path in the weighted, directed graph of managed entities; and
determining if at least one additional path in the weighted, directed graph of managed entities has a cost equivalent to the lowest-cost path which has been determined.

3. The method according to claim 2, further comprising:
adjusting at least one weighting function associated with at least one edge connecting one or more nodes of at least one of the lowest-cost path and the at least one additional path.

4. The method according to claim 2, further comprising:
comparing a quantity of the at least two paths to a sum that includes the lowest-cost path and a quantity of the at least one additional paths; and
creating an error message if the sum of the lowest-cost path and the quantity of at least one additional paths is greater than the quantity of the at least two paths.

5. The method according to claim 3, further comprising:
adjusting at least one weighting function associated with at least one edge connecting one or more nodes of at least one of the lowest-cost path and the at least one additional path if the sum of the lowest-cost path and the quantity of at least one additional paths is less than the quantity of the at least two paths.

6. The method according to claim 1, further comprising:
grouping at least two policies in the one or more policies by a function, whereby the function is used to coordinate a change in the weighting function determined by each respective policy which has been grouped.

7. The method according to claim 1, further comprising:
determining, after the adjusting, a lowest-cost path in the weighted, directed graph of managed entities;
determining, after the adjusting, an additional path that has a cost greater than the lowest-cost path and shares at least one node with the lowest cost path; and
adjusting at least one weighting function associated with at least one edge in the additional path having the cost greater than the lowest cost path so that the lowest cost path and the additional path do not share the at least one node.

8. A device for resolving policy conflicts, the device comprising:
a memory adapted to store:
a weighted, directed graph of managed entities; and
computer executable instructions; and
a processor communicatively coupled to the memory, the processor adapted to:
determining if at least two paths in the weighted, directed graph of managed entities have an equivalent cost that is better than a cost of all other paths in the weighted, directed graph of managed entities, where weights are determined by one or more policies and the cost is a quantitative measurement of a cumulative value of the weights assigned to each edge making up the at least two paths; and
adjusting at least one weighting function associated with at least one edge connecting one or more nodes of the at least two paths.

9. The device according to claim 8, wherein the processor is further adapted to:
determining, after the adjusting, a lowest-cost path in the weighted, directed graph of managed entities; and
determining if at least one additional path in the weighted, directed graph of managed entities has a cost equivalent to the lowest-cost path which has been determined.

10. The device according to claim 9, wherein the processor is further adapted to:
adjust at least one weighting function associated with at least one edge connecting one or more nodes of at least one of the lowest-cost path and the at least one additional path.

11. The device according to claim 9, wherein the processor is further adapted to:
compare a quantity of the at least two paths to a sum that includes the lowest-cost path and the quantity of at least one additional paths; and
create an error message if the sum of the lowest-cost path and the quantity of at least one additional paths is greater than the quantity of the at least two paths.

12. The device according to claim 10, wherein the processor is further adapted to:
adjust at least one weighting function associated with at least one edge connecting one or more nodes of at least one of the lowest-cost path and the at least one additional path if the sum of the lowest-cost path and the quantity of at least one additional paths is less than the quantity of the at least two paths.

13. A method for resolving policy conflicts, the method comprising:
representing each state change of a managed entity as a separate node in a weighted, directed graph;
representing at least one of the separate nodes as one of either a multigraph, a hypergraph, and a pseudograph of different states of a set of managed entities;
representing a state transition as an edge connecting a first of the separate nodes having a first state value to a second of the separate nodes having a second state value;
determining a cost of each edge that is part of a set of edges that form at least two paths connecting the first node and the second by applying at least one policy to each edge, the first and second nodes representing an initial and a final state change of the managed entity and the cost is a quantitative measurement of a cumulative value of the weights assigned to each edge making up the path between the first and second nodes;
determining if at least two paths in the graph have an equivalent cost that is better than a cost of all other paths in the graph, where weights are determined by policy; and
adjusting at least one weighting function associated with at least one edge of at least one of the at least two paths in response to the determining if the at least two paths have an equivalent cost.

14. The method according to claim 13, further comprising:
determining, after the adjusting, a lowest-cost path in the weighted, directed graph of managed entities; and
determining if at least one additional path in the weighted, directed graph of managed entities has a cost equivalent to the lowest-cost path which has been determined.

15. The method according to claim 14, further comprising:
adjusting at least one weighting function associated with at least one edge connecting one or more nodes of at least one of the lowest-cost path and the at least one additional path.

16. The method according to claim 14, further comprising:
comparing a quantity of the at least two paths to a sum that includes the lowest-cost path and the quantity of at least one additional paths; and
creating an error message if the sum of the lowest-cost path and the quantity of at least one additional paths is greater than the quantity of the at least two paths.

17. The method according to claim 14, further comprising:
adjusting at least one weighting function associated with at least one edge connecting one or more nodes of at least one of the lowest-cost path and the at least one additional path if the sum of the lowest-cost path and the quantity of at least one additional paths is less than the quantity of the at least two paths.
